(19) United States
(12) Patent Application Publication
(10) Pub. No.: US 2026/0311222 A1
(43) Pub. Date: Oct. 8, 2026

(54) PROCESSING APPARATUS, PROCESSING METHOD, AND NON-TRANSITORY COMPUTER-READABLE MEDIUM

(71) Applicant: NEC Corporation, Minato-ku, Tokyo (JP)

(72) Inventors: Norihito OI, Tokyo (JP); Tooru IWAMOTO, Tokyo (JP); Tatsuya OSADA, Tokyo (JP)

(73) Assignee: NEC Corporation, Minato-ku, Tokyo (JP)

(21) Appl. No.: 19/108,190

(22) PCT Filed: Oct. 5, 2022
(86) PCT No.: PCT/JP2022/037242

§ 371 Date: Mar. 3, 2025

(51) Int. Cl. G06Q 30/0283

(52) U.S. Cl. CPC G06Q 30/0283

(57) ABSTRACT

The present invention provides a processing apparatus (10) including a result information accumulation unit (11) that acquires result information relating to a utilization result of a storage battery, and accumulates the acquired result information in a result storage unit, a residual value information accumulation unit (12) that acquires residual value information relating to a residual value of the storage battery computed based on the result information by at least one computation method, and accumulates the acquired residual value information in a residual value storage unit, and an issuing unit (13) that executes issue processing of a diagnosis outcome indicating at least one specified residual value among the residual values computed by the at least one computation method.

### TECHNICAL FIELD

The present invention relates to a processing apparatus, a processing method, and a medium.

### BACKGROUND ART

Techniques related to the present invention are disclosed in Patent Documents 1 to 3.

Patent Document 1 discloses a battery deterioration determination system. The battery deterioration determination system is connected, via a communication network, to an on-vehicle device mounted on a vehicle. Then, the battery deterioration determination system receives a state quantity of a battery mounted on each of a plurality of on-vehicle devices, and performs deterioration determination of the battery.

Patent Document 2 discloses a technique for computing a state of charge (SOC) by use of quiescent voltage (QV) instead of open circuit voltage (OCV). The QV is voltage measured in a state where there is a possibility that a small quantity of current resulting from a standby state of equipment flows.

Patent Document 3 discloses a technique for computing a deterioration state of a battery of an electric vehicle (EV) from a vehicle characteristic (weight and the like), a road condition, an external environment, and the like.

### RELATED DOCUMENT

### Patent Document

Patent Document 1: Japanese Patent Application Publication No. 2021-124419
Patent Document 2: EP1598913A2
Patent Document 3: US2013/0085696A1

### DISCLOSURE OF THE INVENTION

### Technical Problem

Electric equipment, such as an electrically-powered vehicle, with electric power as a power source is widespread. Accordingly, a technique that allows a user owning electric equipment to easily acquire a diagnosis outcome of a residual value of the electric equipment of the user is desired.

In a diagnosis of a residual value of electric equipment, a residual value of a storage battery provided in the electric equipment is an extremely important indicator. The residual value of the storage battery is indicated by, for example, a state of health (SOH).

The SOH is computed, for example, based on a measured value of discharge current in a case of completely discharging from a fully charged state. However, since a storage battery in recent years has become larger in capacity, time and a burden of cost become large in a case of such a measurement method. Hence, a large number of computation methods of predicting an SOH from various types of data such as usage data of electric equipment, environmental data, and charging history data have been developed. A problem of the time and the burden of cost described above can be reduced by utilizing the computation methods.

However, a user owning electric equipment cannot easily determine which of the various computation methods to utilize to diagnose a residual value of a storage battery provided in the electric equipment of the user. Naturally, the choice affects a prediction outcome of an SOH, i.e., a diagnosis outcome of a residual value of the electric equipment of the user. Moreover, it takes much effort for the user to diagnose a residual value of a storage battery by use of each of the various computation methods. Hence, a technique for providing a user with a diagnosis outcome of a residual value of a storage battery computed by a computation method desired by the user becomes necessary.

Patent Document 1 discloses a technique for performing deterioration determination of a battery mounted on an on-vehicle device. Patent Document 2 discloses a technique for computing an SOC by use of QV. Patent Document 3 discloses a technique for computing a deterioration state of a battery of an electric vehicle (EV) from a vehicle characteristic (weight and the like), a road condition, an external environment, and the like. However, none of Patent Documents 1 to 3 disclose or suggest a technique for providing a user with a diagnosis outcome of a residual value of a storage battery computed by a computation method desired by the user.

In view of the problem described above, one example of an object of the present invention is to provide a processing apparatus, a processing method, and a medium that solve a challenge of providing a user with a diagnosis outcome of a residual value of a storage battery computed by a computation method desired by the user.

### Solution to Problem

According to an example aspect of the present invention, there is provided a processing apparatus including:
a result information accumulation unit that acquires result information relating to a utilization result of a storage battery, and accumulates the acquired result information in a result storage unit;
a residual value information accumulation unit that acquires residual value information relating to a residual value of the storage battery computed based on the result information by at least one computation method, and accumulates the acquired residual value information in a residual value storage unit; and
an issuing unit that executes issue processing of a diagnosis outcome indicating at least one specified residual value among the residual values computed by the at least one computation method.

Moreover, according to an example aspect of the present invention, there is provided a processing method including,
by one or more computers:
   acquiring result information relating to a utilization result of a storage battery, and accumulating the acquired result information in a result storage unit;
acquiring residual value information relating to a residual value of the storage battery computed based on the result information by at least one computation method, and accumulating the acquired residual value information in a residual value storage unit; and
executing issue processing of a diagnosis outcome indicating at least one specified residual value among the residual values computed by the at least one computation method.

Moreover, according to an example aspect of the present invention, there is provided a medium recording a program causing a computer to function as:
a result information accumulation unit that acquires result information relating to a utilization result of a storage battery, and accumulates the acquired result information in a result storage unit;
a residual value information accumulation unit that acquires residual value information relating to a residual value of the storage battery computed based on the result information by at least one computation method, and accumulates the acquired residual value information in a residual value storage unit; and
an issuing unit that executes issue processing of a diagnosis outcome indicating at least one specified residual value among the residual values computed by the at least one computation method.

### Advantageous Effects of Invention

According to one example aspect of the present invention, a processing apparatus, a processing method, and a medium that solve a challenge of providing a user with a diagnosis outcome of a residual value of a storage battery computed by a computation method desired by the user are achieved.

### BRIEF DESCRIPTION OF THE DRAWINGS

The above-described object, other objects, features, and advantageous effects will become more apparent from a public example embodiment described below and the following accompanying drawings.

FIG. 1 It is one example of a functional block diagram of a processing apparatus.

FIG. 2 It is a diagram for describing an outline of one example of processing of the processing apparatus.

FIG. 3 It is a diagram illustrating one example of a hardware configuration of the processing apparatus.

FIG. 4 It is a sequence diagram illustrating one example of a flow of processing executed by the processing apparatus.

FIG. 5 It is a sequence diagram illustrating another example of a flow of processing executed by the processing apparatus.

FIG. 6 It is a diagram illustrating one example of information processed by the processing apparatus.

FIG. 7 It is a sequence diagram illustrating another example of a flow of processing executed by the processing apparatus.

FIG. 8 It is a diagram schematically illustrating one example of a screen output by the processing apparatus.

FIG. 9 It is a diagram schematically illustrating one example of a diagnosis outcome issued by the processing apparatus.

FIG. 10 It is a diagram for describing an outline of another example of processing of the processing apparatus.

FIG. 11 It is another example of a functional block diagram of the processing apparatus.

FIG. 12 It is a sequence diagram illustrating another example of a flow of processing executed by the processing apparatus.

FIG. 13 It is a sequence diagram illustrating another example of a flow of processing executed by the processing apparatus.

FIG. 14 It is another example of a functional block diagram of the processing apparatus.

FIG. 15 It is a diagram illustrating another example of information processed by the processing apparatus.

### EXAMPLE EMBODIMENT

Hereinafter, example embodiments of the present invention are described by use of the drawings. Note that, in all of the drawings, a similar component is assigned with a similar reference sign, and description thereof is omitted as appropriate.

### First Example Embodiment

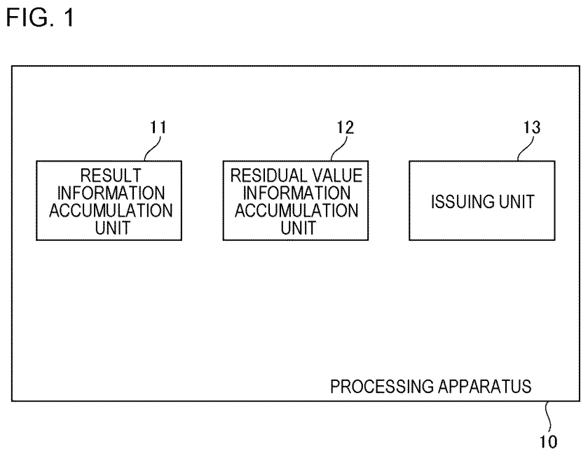

FIG. 1 is a functional block diagram illustrating an outline of a processing apparatus 10 according to the first example embodiment. The processing apparatus 10 includes a result information accumulation unit 11, a residual value information accumulation unit 12, and an issuing unit 13.

The result information accumulation unit 11 acquires result information relating to a utilization result of a storage battery, and accumulates the result information in a result storage unit. The residual value information accumulation unit 12 acquires residual value information relating to a residual value of the storage battery computed based on the result information by at least one computation method, and accumulates the residual value information in a residual value storage unit. The issuing unit 13 executes issue processing of a diagnosis outcome indicating at least specified one residual value among the residual values computed by the at least one computation method.

The processing apparatus 10 including the result information accumulation unit 11 can acquire result information relating to a utilization result of a storage battery provided in electric equipment owned by a user, and accumulate the result information. Moreover, the processing apparatus 10 including the residual value information accumulation unit 12 can acquire residual value information relating to a residual value of the storage battery computed based on the result information by at least one computation method, and accumulate the residual value information. Then, the processing apparatus 10 including the issuing unit 13 can issue a diagnosis outcome indicating a residual value specified by the user among the residual values indicated by the accumulated residual value information. As a consequence, according to the processing apparatus 10, a challenge of providing a user with a diagnosis outcome of a residual value of a storage battery computed by a computation method desired by the user is solved.

### Second Example Embodiment

### Outline

The processing apparatus 10 according to the present example embodiment is an embodied form of the processing apparatus 10 according to the first example embodiment. An outline of the processing apparatus 10 is as follows.

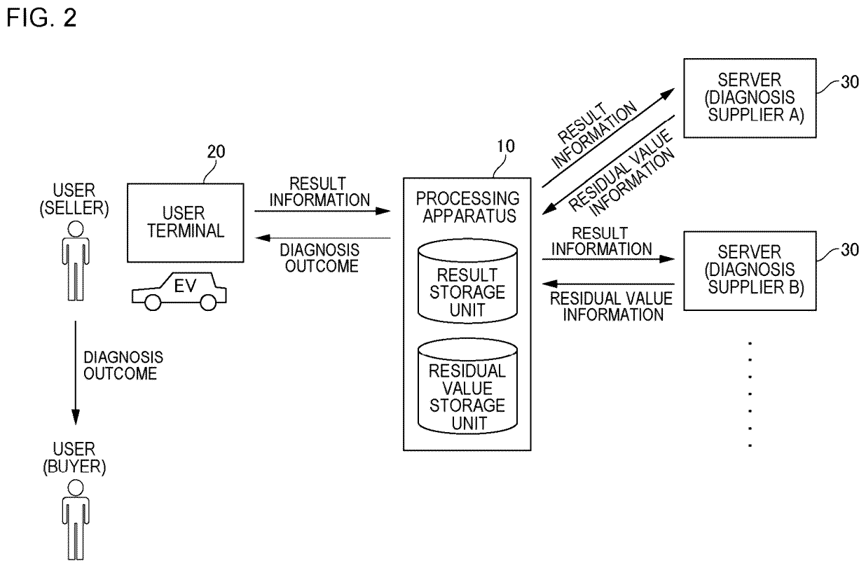

As illustrated in FIG. 2, in a service utilizing the processing apparatus 10, the processing apparatus 10, a user terminal 20, and a server 30 cooperate.

The processing apparatus 10 is an apparatus managed by a supplier (service supplier) involved in a service that provides a user (seller) with a diagnosis outcome of a residual value of a storage battery computed by various computation methods. The processing apparatus 10 acquires, from the user terminal 20, result information relating to a utilization result of the storage battery, and accumulates the result information. Moreover, the processing apparatus 10 provides the result information to the server 30, acquires, from the server 30, residual value information computed based on the result information, and accumulates the residual value information. Then, the processing apparatus 10 issues a diagnosis outcome, based on the accumulated residual value information, and transmits the diagnosis outcome to the user terminal 20.

The user terminal 20 is an apparatus managed by a user (seller) who wishes for a diagnosis outcome of a residual value of a storage battery provided in electric equipment owned. The user terminal 20 transmits result information to the processing apparatus 10. Moreover, the user terminal 20 acquires a diagnosis outcome from the processing apparatus 10.

The server 30 is an apparatus managed by a supplier (diagnosis supplier) that diagnoses a residual value of a storage battery of a user (seller). The server 30 acquires result information from the processing apparatus 10. Moreover, the server 30 computes residual value information, based on the result information. Then, the server 30 transmits the computed residual value information to the processing apparatus 10.

The user (seller) utilizes the acquired diagnosis outcome for various purposes. As one example, utilization in a secondhand market can be cited. For example, the user (seller) sells his/her electric equipment in the secondhand market by attaching the acquired diagnosis outcome. A user (buyer) confirms, based on the diagnosis outcome, a state of a storage battery of the electric equipment sold in the secondhand market, in such a way as to serve as a material for determining whether to purchase the storage battery.

### Hardware Configuration

Next, one example of the hardware configuration of the processing apparatus 10 is described. Each functional unit of the processing apparatus 10 is achieved by any combination of hardware and software mainly including a central processing unit (CPU) of any computer, a memory, a program loaded onto the memory, a storage unit such as a hard disk that stores the program (that can store not only a program previously stored from a phase of shipping an apparatus but also a program downloaded from a storage medium such as a CD or a server or the like on the Internet), and an interface for network connection. Then, it is appreciated by a person skilled in the art that there are a variety of modified examples of a method and an apparatus for the achievement.

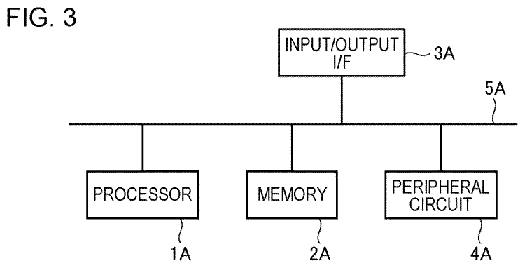

FIG. 3 is a block diagram illustrating a hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 may not have the peripheral circuit 4A. Note that, the processing apparatus 10 may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic outcome of each of the modules.

### Functional Configuration

Next, a functional configuration of the processing apparatus 10 is described. FIG. 1 illustrates one example of a functional block diagram of the processing apparatus 10. As illustrated in the figure, the processing apparatus 10 includes a result information accumulation unit 11, a residual value information accumulation unit 12, and an issuing unit 13.

The result information accumulation unit 11 acquires result information relating to a utilization result of a storage battery, and accumulates the result information in a result storage unit. The result information accumulation unit 11 can repeatedly acquire result information of the storage battery, and accumulate the result information in the result storage unit. As a consequence, historical data of result information of the storage battery are accumulated in the result storage unit. Moreover, the result information accumulation unit 11 can acquire result information of each of a plurality of storage batteries, and accumulate each piece of the result information in the result storage unit in association with identification information of each of the plurality of storage batteries.

A “storage battery” is an apparatus including a function, included in electric equipment, of storing electricity. The electric equipment is driven by use of electricity stored in the storage battery. The storage battery is called a secondary battery or a battery. A size and a configuration of a storage battery are not particularly limited.

The “result storage unit” is a non-volatile memory. The result storage unit may be provided within the processing apparatus 10, or may be provided in an external apparatus communicably connected to the processing apparatus 10.

“Result information” is various types of information utilized for computation of a residual value of a storage battery by a diagnosis supplier. For example, result information includes various types of data such as charging history data, environmental data, and usage data.

“Charging history data” are data relating to charging processing executed for a storage battery. Charging history data include, for example, the number of times of charging, a measured value of voltage and current during charging, an SOC at start of charging, an SOC at end of charging, and the like. The data can be measured, for example, by a sensor or the like provided in a storage battery.

“Environmental data” are data relating to a utilization environment of electric equipment including a storage battery. Environmental data include, for example, temperature, humidity, weather, location information, and the like. The data may be measured, for example, by a sensor provided in a storage battery or electric equipment, or may be acquired from a predetermined server (such as a server that provides weather information).

“Usage data” are data indicating usage status of electric equipment including a storage battery. Usage data have a content according to a type of electric equipment. Electric equipment is, for example, an electrically-powered vehicle, but is not limited thereto. For example, in a case where electric equipment is an electrically-powered vehicle, travel data (a travel distance, a travel location, a velocity, acceleration, data indicating an operation content of a steering wheel, a brake, an accelerator, and the like, and the like) become usage data. The data can be measured, for example, by a sensor or the like provided in electric equipment.

An “electrically-powered vehicle” is a vehicle that travels with electrical energy as power source. An electrically-powered vehicle can be exemplified by, for example, an electric car, a plug-in hybrid car, a hybrid car, a fuel cell car, and the like, but is not limited thereto.

Herein, one example of a means by which the result information accumulation unit 11 acquires result information is described. The result information accumulation unit 11 can acquire result information from the user terminal 20. The user terminal 20 may be electric equipment itself including a communication function. Moreover, in a case where electric equipment is an electrically-powered vehicle, the user terminal 20 may be in-vehicle equipment including a communication function installed within the vehicle. Moreover, the user terminal 20 may be a communication apparatus such as a smartphone, a tablet terminal, a smartwatch, a personal computer, or the like.

First, data as described above are continuously measured with, for example, a sensor provided in electric equipment or a storage battery, and accumulated in any storage apparatus provided within the electric equipment.

Then, for example, electric equipment or in-vehicle equipment including a communication function may transmit result information to the processing apparatus 10. Transmission timing varies, and, for example, data accumulated so far may be transmitted at predetermined timing (predetermined time) every day, data accumulated so far may be transmitted at timing at which an operation of turning on or off a power source of the electric equipment is accepted, or data accumulated so far may be transmitted at timing at which a transmission instruction from a user is accepted, or may be transmitted at other timing. Moreover, the electric equipment or the in-vehicle equipment may transmit data to the processing apparatus 10 by real-time processing.

Alternatively, the user may move data accumulated in the storage apparatus to another device (a smartphone, a tablet terminal, a smartwatch, a portable storage apparatus, or the like) by any means. Then, the user may transmit data moved to another device to the processing apparatus 10 by utilizing any communication terminal (a smartphone, a tablet terminal, a smartwatch, a personal computer, or the like).

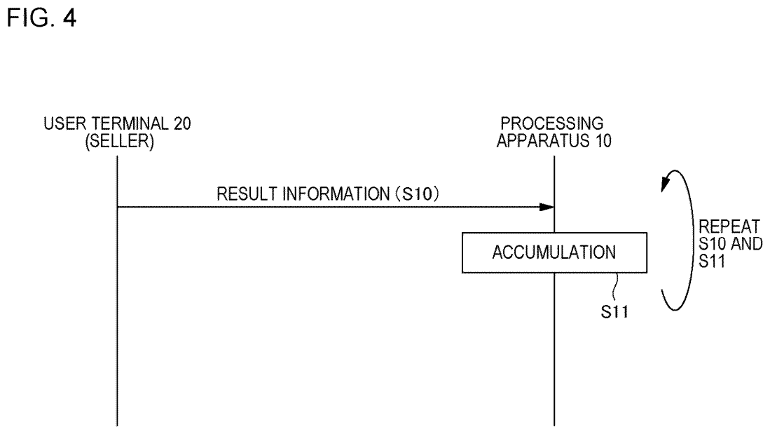

A sequence diagram in FIG. 4 illustrates one example of a flow of processing achieved by the result information accumulation unit 11. As illustrated in the figure, the user terminal 20 transmits result information to the processing apparatus 10 at predetermined timing (S10). The processing apparatus 10 accumulates the received result information in the result storage unit (S11). Thereafter, the processing is repeated.

Returning to FIG. 1, the residual value information accumulation unit 12 acquires residual value information relating to a residual value of a storage battery computed based on result information accumulated in the result information accumulation unit 11, by at least one, for example, a plurality of computation methods, and accumulates the residual value information in a residual value storage unit.

The “residual value storage unit” is a non-volatile memory. The residual value storage unit may be provided within the processing apparatus 10, or may be provided in an external apparatus communicatively connected to the processing apparatus 10.

The “residual value of the storage battery” is indicated by an SOH.

The “residual value information” indicates a current SOH. The residual value information may further indicate a predicted value of an SOH at predetermined future timing. A future SOH is, for example, an SOH one year later, an SOH three years later, an SOH five years later, or the like.

The residual value information accumulation unit 12 transmits the result information accumulated in the result storage unit, to an external apparatus (the server 30 of the diagnosis supplier) that computes residual value information, based on the result information. Then, the residual value information accumulation unit 12 acquires the residual value information from the external apparatus, and accumulates the residual value information in the residual value storage unit.

The residual value information accumulation unit 12 can transmit result information to a plurality of external apparatuses, and acquire residual value information from a plurality of external apparatuses.

The servers 30 of the diagnosis suppliers each compute residual value information by a unique computation method. Details of the computation method are not particularly limited. The plurality of computation methods may differ from each other in data to be utilized for computation. Moreover, a plurality of computation methods may differ from each other in an algorithm of computation.

Moreover, as described above, result information accumulated in the result storage unit is updated at any time. The servers 30 of the diagnosis suppliers can each acquire result information from the processing apparatus 10 at a unique frequency/timing, and compute residual value information. For example, the server 30 of a certain diagnosis supplier may acquire result information from the processing apparatus 10 once a month, and compute residual value information. Then, the server 30 of another diagnosis supplier may acquire result information from the processing apparatus 10 once a week, and compute residual value information. Note that, the servers 30 of all diagnosis suppliers may acquire result information from the processing apparatus 10 at the same frequency/timing, and compute residual value information.

A frequency/timing of transmitting result information to the server 30 of each diagnosis supplier may be previously registered in the processing apparatus 10. Then, the residual value information accumulation unit 12 may transmit result information to the server 30 of each diagnosis supplier at the frequency/timing, and acquire the residual value information. Alternatively, a frequency/timing of acquiring result information may be registered in the server 30 of each diagnosis supplier. Then, the server 30 of each diagnosis supplier may transmit a request for result information to the processing apparatus 10 at the frequency/timing. In this case, the residual value information accumulation unit 12 transmits result information to the server 30 of each diagnosis supplier in response to a request from the server 30 of each diagnosis supplier.

Note that, the server 30 of one diagnosis supplier may compute the residual value information by one computation method, or may compute residual value information by each of a plurality of different computation methods. In a case where the server 30 of one diagnosis supplier computes the residual value information by each of a plurality of computation methods different from each other, frequencies/timings of computing may be the same as each other, or may be different from each other.

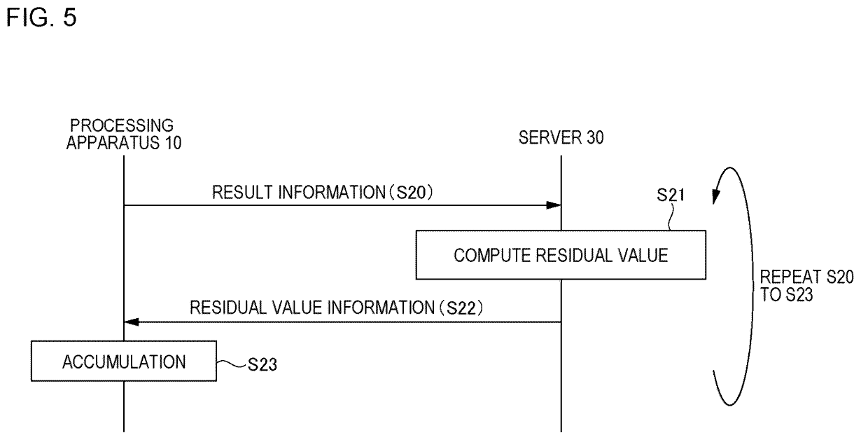

A sequence diagram in FIG. 5 illustrates one example of a flow of processing achieved by the residual value information accumulation unit 12. As illustrated in the figure, the processing apparatus 10 transmits result information accumulated in the result storage unit to the server 30 of a diagnosis supplier at a predetermined timing (S20). The server 30 of the diagnosis supplier computes a residual value of a storage battery by a predetermined computation method, based on the received result information (S21). Then, the server 30 of the diagnosis supplier transmits residual value information indicating the computed residual value to the processing apparatus 10 (S22). The processing apparatus 10 accumulates the received residual value information in the residual value storage unit (S23). Thereafter, the processing is repeated.

The processing apparatuses 10 each repeatedly perform the processing illustrated in FIG. 5 with the server 30 of each diagnosis supplier at a unique frequency/timing.

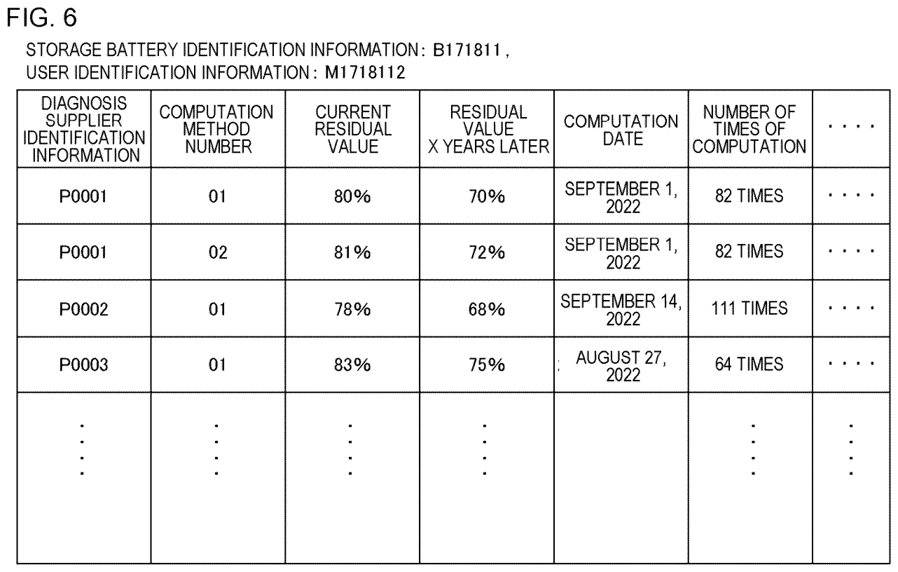

FIG. 6 schematically illustrates one example of information stored in the residual value storage unit. The information illustrated in the figure is information relating to a storage battery identified by storage battery identification information “B171811” of a user identified by user identification information “M1718112”. In the information illustrated in the figure, diagnosis supplier identification information, a computation method number, a current residual value, a residual value X years later, a computation date, and the number of times of computation are associated with each other.

“Diagnosis supplier identification information” is information that identifies a plurality of diagnosis suppliers from each other.

The “computation method number” is information that identifies a computation method implemented by each diagnosis supplier from each other. As described above, one diagnosis supplier may compute a residual value by one computation method, or may compute a residual value by a plurality of computation methods. In the latter case, the computation method number identifies a plurality of computation methods implemented by one diagnosis supplier from each other.

The “current residual value” is a current (computation time point) residual value of a storage battery computed by each computation method of each diagnosis supplier. As described above, a residual value is repeatedly computed by each computation method of each diagnosis supplier. The latest residual value may be indicated in this column.

The “residual value X years later” is a predicted value of a residual value of a storage battery X years later, computed by each computation method of each diagnosis supplier. For example, the predicted value can be a predicted value of a residual value one year later, three years later, five years later, or the like. As described above, a residual value is repeatedly computed by each computation method of each diagnosis supplier. The latest predicted value may be indicated in this column.

The “computation date” is a computation date of a value indicated in a column of a current residual value and a column of a residual value X years later. As described above, computation of a residual value can be performed at a unique frequency/timing for each computation method of each diagnosis supplier. Thus, as illustrated in the figure, a computation date of the latest “current residual value” and “residual value X years later” registered at a certain time point can differ for each computation method.

The “number of times of computation” is the number of times of computation of a residual value implemented so far. As described above, computation of a residual value can be performed at a unique frequency/timing for each computation method of each diagnosis supplier. Thus, as illustrated in the figure, the number of times of computation at a certain time point can differ for each computation method.

Returning to FIG. 1, the issuing unit 13 executes issue processing of a diagnosis outcome indicating at least specified one residual value among the residual values computed by at least one, for example, a plurality of computation methods.

Specifically, the issuing unit 13 presents the user with information relating to the residual value computed by at least one computation method, and accepts a user input specifying at least one residual value from among the residual values. Then, the issuing unit 13 performs issue processing of a diagnosis outcome indicating at least one specified residual value. Note that, the issuing unit 13 may execute processing for a predetermined fee to be paid to a diagnosis supplier involved in a computation method that has computed the at least one specified residual value. The processing may be, for example, registration that the computation method has been specified. Alternatively, the processing may be processing of counting the number of times being specified for each computation method.

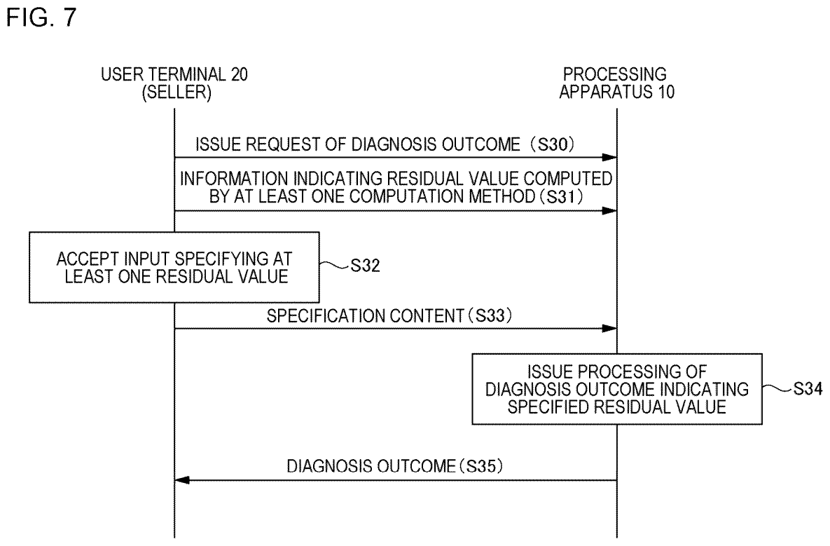

A sequence diagram in FIG. 7 illustrates one example of a flow of processing achieved by the residual value information accumulation unit 12.

As illustrated in the figure, the processing apparatus 10 acquires an issue request of a diagnosis outcome from the user terminal 20 (S30).

The user terminal 20 may be electric equipment itself including a communication function. Moreover, in a case where the electric equipment is an electrically-powered vehicle, the user terminal 20 may be in-vehicle equipment. Moreover, the user terminal 20 may be a communication apparatus such as a smartphone, a tablet terminal, a smartwatch, or a personal computer. Note that, the user terminal 20 that transmits result information to the processing apparatus 10 and the user terminal 20 utilized in issue processing of a diagnosis outcome may be the same terminal or different terminals.

The user operates the user terminal 20, and accesses the processing apparatus 10 via an application or a web page involved in the processing apparatus 10. Then, the user performs an issue request of a diagnosis outcome via a user interface (UI) screen on the application or the web page. Note that, in the operation of the issue request, specification of user identification information and specification of storage battery identification information may be performed.

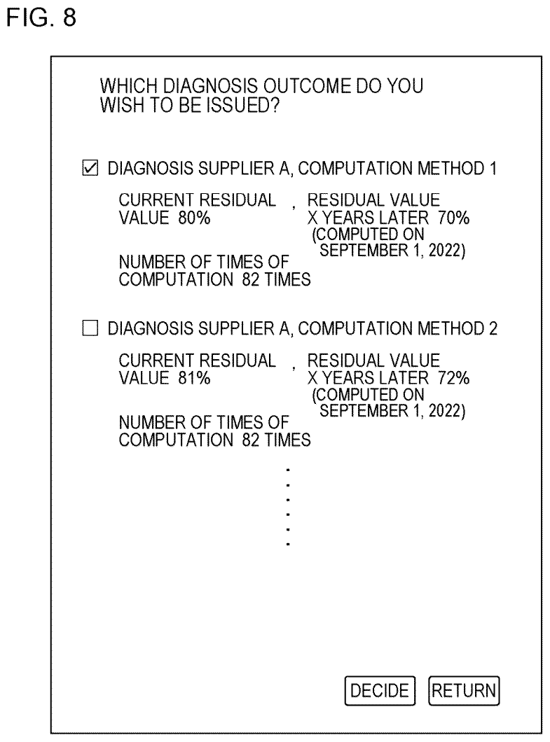

In response to the issue request, the processing apparatus 10 transmits, to the user terminal 20, information indicating a residual value computed by at least one computation method (S31). The user terminal 20 displays the information on a display. One example of the information is illustrated in FIG. 8.

In the information illustrated in FIG. 8, information relating to a residual value computed by a plurality of computation methods is displayed in a list. Specifically, for each computation method, a current residual value, a residual value X years later, computation dates thereof, the number of times of computation so far, a diagnosis supplier name, a computation method, and the like are indicated. Then, a UI component (check box) for specifying at least one residual value from among the residual values is indicated. Note that, one residual value may be specified by utilizing a UI component such as a radio button. The information to be transmitted is generated based on the information (refer to FIG. 6) stored in the residual value storage unit.

After this, the user terminal 20 accepts a user input specifying at least one residual value (S32). Then, the user terminal 20 transmits, to the processing apparatus 10, a specification content indicating which residual value has been specified (S33).

Subsequently, the processing apparatus 10 performs a processing of issuing a diagnosis outcome indicating at least one specified residual value (S34). Then, the processing apparatus 10 transmits the issued diagnosis outcome to the user terminal 20 (S35).

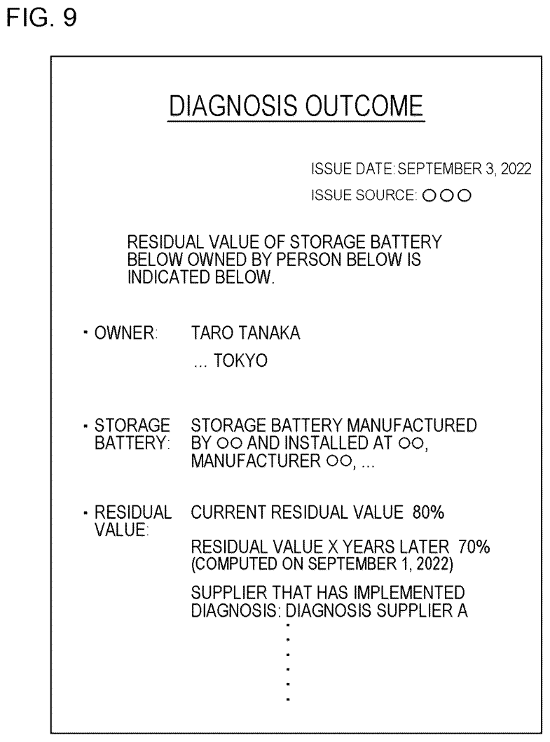

In the processing of issuing a diagnosis outcome, the processing apparatus 10 generates a diagnosis outcome in, for example, a previously determined format. FIG. 9 illustrates one example of a diagnosis outcome generated by the processing apparatus 10. The illustrated diagnosis outcome includes an issue date, an issue source, information (a name, an address, and the like) relating to an owner of a storage battery, information (a manufacturer of a storage battery, a type and a manufacturer of electric equipment including a storage battery, and the like) relating to the storage battery, a residual value, information (name, and the like) relating to a diagnosis supplier that has computed the residual value, and the like. Note that, the diagnosis outcome may not include some of pieces of the information, or may include other pieces of information. Moreover, the diagnosis outcome may be issued under another name such as a “diagnostic certificate”.

A diagnosis outcome is preferably data in a format in which it is difficult to tamper with the data. For example, the data may be recorded on a block chain, may be or generated in another data format.

### Advantageous Effect

The processing apparatus 10 can acquire result information relating to a utilization result of a storage battery from a user owning electric equipment, and accumulates the result information. Moreover, the processing apparatus 10 can transmit the accumulated result information to the server 30 of at least one diagnosis supplier, acquire residual value information of the storage battery that the server 30 has computed based on the result information, and accumulate the residual value information. Then, the processing apparatus 10 can present, in response to a request from a user, a residual value computed by at least one computation method, and issue a diagnosis outcome indicating at least one specified value from among the residual values.

According to the processing apparatus 10 as above, a challenge of providing a user with a diagnosis outcome of a residual value of a storage battery computed by a computation method desired by the user is solved.

Moreover, since a user can acquire the diagnosis outcome relatively easily, it becomes easy to sell his/her electric equipment in a secondhand market. Further, a user considering purchase of electric equipment in the secondhand market can confidently perform, based on the diagnosis outcome, assessment and quality confirmation of a product in the secondhand market. As a consequence, further spread of electric equipment and spread of a secondhand market for electric equipment are expected.

### Third Example Embodiment

A processing apparatus 10 according to the present example embodiment includes a function of supporting an operation of a user of specifying at least one residual value from among residual values of a storage battery computed by at least one computation method (an operation of specifying at least one residual value on such a UI screen as illustrated in FIG. 8). Specifically, the processing apparatus 10 includes a function of presenting a user with a material for determining which computation method to specify. Detail description is given below.

An issuing unit 13 outputs characteristic information of each computation method to a user, in association with a residual value computed by at least one computation method. The issuing unit 13 can transmit the information to a user terminal 20 in response to an issue request of a diagnosis outcome from the user terminal 20 (S30 in FIG. 7). For example, characteristic information of each computation method is displayed on a screen indicating a residual value computed by at least one computation method as illustrated in FIG. 8.

After this, the issuing unit 13 accepts a user input specifying a residual value computed by at least one computation method, and executes issue processing of a diagnosis outcome indicating the residual value specified by the user input.

The “characteristic information of each computation method” indicates at least one of the number of times of computation of residual value information performed so far in relation to a storage battery, a reliability degree, a result of being specified in a past as a computation method of executing issue processing of a diagnosis outcome, word-of-mouth information, and a result of predetermined processing utilizing an issued diagnosis outcome.

“The number of times of computation of residual value information performed so far in relation to a storage battery” is the number of times of computation illustrated in FIGS. 6 and 8 described in the second example embodiment. It is considered that, as the number of times of computation is larger, it becomes easy for a user to rely on an outcome of the computation.

A “reliability degree” is a reliability degree of each computation method. While there are various computation methods of a reliability degree, one example is described in a fifth example embodiment.

“A result of being specified in a past as a computation method of executing issue processing of a diagnosis outcome” indicates the number of times of being specified in a past as a computation method of executing the issue processing of a diagnosis outcome. In other words, the number of times of being specified in a past is indicated on such a UI screen as illustrated in FIG. 8. It is considered that, as the number of times of being specified is larger, it becomes easy for a user to rely on an outcome of the computation.

“Word-of-mouth information” is information relating to each computation method registered by an unspecified user. Word-of-mouth information may include, for example, a comment registered by a user. Moreover, word-of-mouth information may include, for example, an evaluation outcome (example: an outcome of 5-point evaluation) registered by a user.

“A result of predetermined processing utilizing an issued diagnosis outcome” indicates a selling outcome in a secondhand market utilizing a diagnosis outcome computed by each computation method. In other words, the “predetermined processing” is selling in a secondhand market, and a “result” indicates a selling outcome. Specifically, a result indicates the number of times buying and selling have been accomplished. Moreover, a result may indicate at least one of a statistical value (an average value, a minimum value, a maximum value, a mode, a median, and the like) of a time from listing in the secondhand market to accomplishment of buying and selling. The data are generated, for example, based on information provided from a user who has issued a diagnosis outcome. Specifically, after a diagnosis outcome is issued, a questionnaire inquiring about presence or absence of accomplishment of buying and selling, a time from listing to accomplishment of buying and selling, and the like is provided to a user from a service supplier by any unit. Then, the data described above are collected by acquiring an answer to the questionnaire.

Other components of the processing apparatus 10 according to the present example embodiment are similar to those according to the first and second example embodiments.

The processing apparatus 10 according to the present example embodiment achieves an advantageous effect similar to those according to the first and second example embodiments. Moreover, the processing apparatus 10 includes a function of supporting an operation of a user of specifying at least one residual value from among residual values of a storage battery computed by at least one computation method. Specifically, the processing apparatus 10 includes a function of presenting a user with a material for determining which computation method to specify. According to the processing apparatus 10 as above, a user can easily specify a desired computation method.

### Fourth Example Embodiment

A processing apparatus 10 according to the present example embodiment includes a function for enhancing reliability of a residual value of a storage battery computed by each diagnosis supplier.

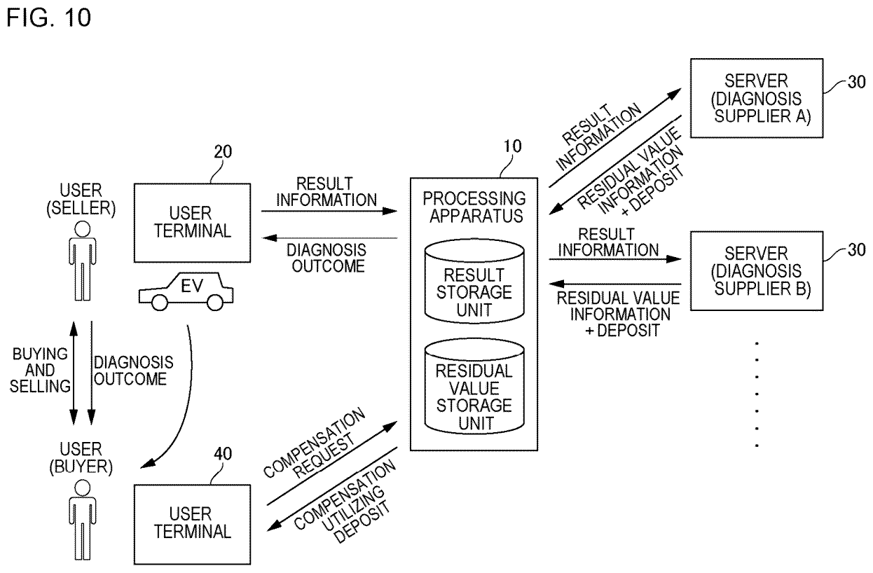

An overall picture of the function is described by use of FIG. 10. The processing apparatus 10 acquires residual value information from a diagnosis supplier that has computed a residual value of a storage battery, and accepts a deposit (deposit money). Then, in a case where buying and selling of electric equipment utilizing a diagnosis outcome indicating a residual value of a storage battery computed by a certain diagnosis supplier is accomplished, and then a compensation request relating to performance of the storage battery is accepted from a user of a buyer, the processing apparatus 10 performs compensation to the user of the buyer by use of the deposit of the diagnosis supplier. In this case, some or all of the deposit of the diagnosis supplier do not return to the diagnosis supplier. It is expected that the diagnosis supplier strives to compute a residual value with higher accuracy in order to enhance a refund rate of a deposit. Detailed description is given below.

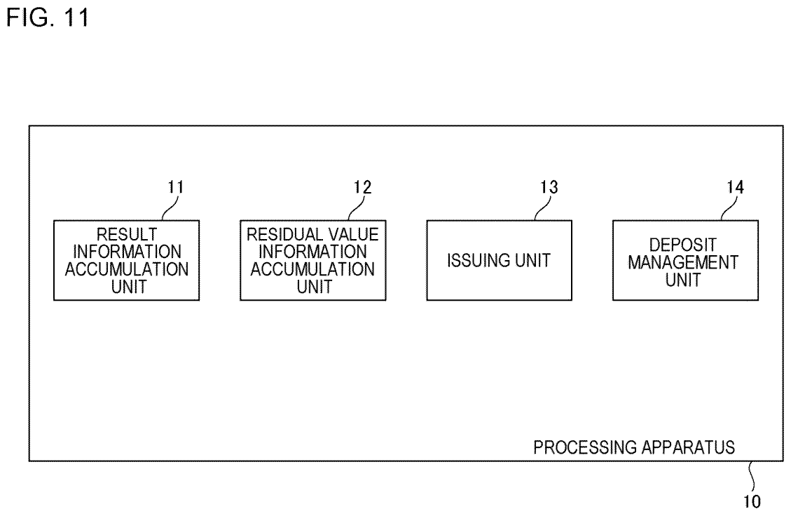

FIG. 11 illustrates one example of a functional block diagram of the processing apparatus 10 according to the present example embodiment. As illustrated in the figure, the processing apparatus 10 includes a result information accumulation unit 11, a residual value information accumulation unit 12, an issuing unit 13, and a deposit management unit 14.

The deposit management unit 14 performs “processing of accepting a deposit from a diagnosis supplier”, “compensation processing utilizing a deposit”, and “refund processing of a deposit”. Each piece of processing is described below.

### -Processing of accepting a deposit from a diagnosis supplier

In a case where the residual value information accumulation unit 12 acquires residual value information and accumulates the residual value information in a residual value storage unit, the deposit management unit 14 accordingly accepts a predetermined deposit from a diagnosis supplier that has computed the residual value information.

The “deposit” is deposit money accepted from a diagnosis supplier. In a case where a buyer user of electric equipment including a storage battery suffers an unforeseen disadvantage due to a diagnosis outcome indicating a residual value of a storage battery computed by the diagnosis supplier, compensation processing using the deposit is executed.

For each time the residual value information accumulation unit 12 acquires residual value information from a server 30 of a diagnosis supplier and accumulates the residual value information in the residual value storage unit, the deposit management unit 14 may accept a deposit from the diagnosis supplier.

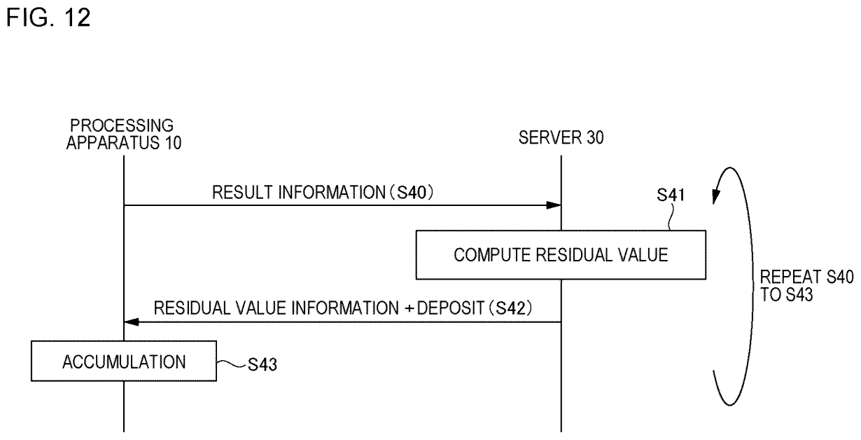

A sequence diagram in FIG. 12 illustrates one example of a flow of the processing achieved by the deposit management unit 14. As illustrated in the figure, the processing apparatus 10 transmits result information accumulated in a result storage unit to the server 30 of a diagnosis supplier at predetermined timing (S40). The server 30 of the diagnosis supplier computes a residual value of a storage battery by a predetermined computation method, based on received result information (S41). Then, the server 30 of the diagnosis supplier transmits residual value information indicating the computed residual value to the processing apparatus 10, and deposits a deposit with the processing apparatus 10 (S42). The processing apparatus 10 accumulates the received residual value information in the residual value storage unit, and accepts the deposit (S43). Thereafter, the processing is repeated.

As described in the second example embodiment, a diagnosis supplier can repeatedly compute the residual value of a storage battery of a certain user. As a consequence, the number of times of computation becomes a plurality as illustrated in FIGS. 6 and 8. The deposit management unit 14 may accept a deposit from the diagnosis supplier in response to each of the a plurality of times of computations. In this case, as the number of times of computation increases, a total amount of a deposit accepted from the diagnosis supplier becomes larger.

As another example, the deposit management unit 14 may accept a predetermined fixed amount of a deposit from a diagnosis supplier that has accumulated residual value information for at least one time in the residual value storage unit. In this case, a deposit accepted from each diagnosis supplier is a fixed amount, regardless of the number of times of computation.

A means of accepting a deposit is not particularly limited, and any technique can be adopted. For example, the deposit management unit 14 may communicate with a server that manages predetermined electronic money, and accept a deposit in predetermined electronic money. Alternatively, the deposit management unit 14 may communicate with a server of a predetermined credit card company, and accept a deposit by payment using a credit card. Alternatively, the deposit management unit 14 may accept a deposit by online transfer processing to a predetermined financial institution such as a bank or a post office.

### Compensation Processing Using A Deposit

First, it is assumed that a diagnosis outcome issued by the issuing unit 13 is utilized in buying and selling of electric equipment including a storage battery. Specifically, a user (seller) sells his/her electric equipment in the secondhand market by attaching the acquired diagnosis outcome. A user (buyer) confirms, based on the diagnosis outcome, a state of the storage battery of the electric equipment being sold in the secondhand market, in such a way as to serve as a material for determining whether to purchase.

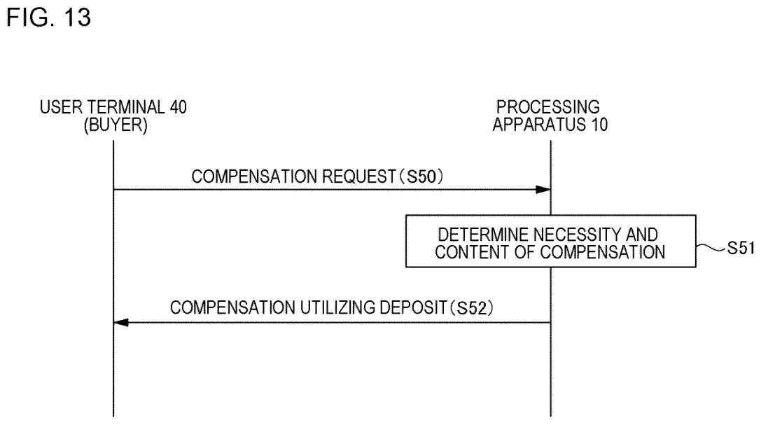

A sequence diagram in FIG. 13 illustrates one example of a flow of processing achieved by the deposit management unit 14. As illustrated in the figure, in a case where the processing apparatus 10 accepts a compensation request from a user terminal 40 of a user (buyer) (S50), the processing apparatus 10 determines necessity of compensation and a compensation content (S51).

Then, the processing apparatus 10 executes compensation utilizing a deposit associated with the computation method that has computed a diagnosis outcome utilized in buying and selling (a deposit deposited by a diagnosis supplier that has computed a residual value indicated by the diagnosis outcome) (S52).

### Acceptance of a Compensation Request (S50)

The user (buyer) operates the user terminal 40, and accesses the processing apparatus 10 via an application or a web page involved in the processing apparatus 10. Then, the user (buyer) performs a compensation request via a UI screen on an application or a web page.

Note that, in an operation of the compensation request, input of information (a name, an address, a telephone number, and the like) of a user requesting compensation, input of information relating to purchased electric equipment and a storage battery included therein (information that identifies the electric equipment and the storage battery), input of information (a name, an address, and a telephone number, and the like) of the seller, input of information (such as diagnosis outcome identification information and a copy of a diagnosis outcome) relating to a diagnosis outcome presented from the seller during buying and selling, and the like may be performed.

### Compensation Processing (S51, S52)

The deposit management unit 14 determines whether to perform compensation and a content of the compensation, based on the residual value of the storage battery indicated in the diagnosis outcome and a residual value of the storage battery at a time point of the compensation request. Specifically, the deposit management unit 14 evaluates accuracy of the residual value of the storage battery indicated in the diagnosis outcome, based on the residual value of the storage battery indicated in the diagnosis outcome and the residual value of the storage battery at a time point of the compensation request. Then, the deposit management unit 14 determines to perform compensation in a case where the accuracy is equal to or less than a criterion level, and not to perform compensation in a case where the accuracy is above the criterion level. Moreover, in a case where compensation is performed, the deposit management unit 14 determines a compensation content, based on a deviation between accuracy and the criterion level. As the deviation is larger, the deposit management unit 14 can decide payment of a larger compensation amount.

While there are various computation methods of accuracy, one example is described below.

For example, the deposit management unit 14 can compute the accuracy, based on a difference (hereinafter, “first difference”) acquired by subtracting a measured value of a residual value of an electric storage place at a compensation request from a residual value of the storage battery at a compensation request predicted based on a diagnosis outcome. As the first difference is larger, the accuracy becomes lower.

Prediction of a residual value of the storage battery at a compensation request based on a diagnosis outcome is computed, for example, as follows.

First, as illustrated in FIG. 9, it is assumed that a diagnosis outcome includes a current (a diagnosis outcome issuance time point, or a computation time point of a residual value indicated in a diagnosis outcome) residual value of a storage battery, and a predicted value of a residual value at predetermined future timing. The deposit management unit 14 predicts, based on the residual values at the two time points, a residual value of a storage battery at any time point between the two time points. For example, the deposit management unit 14 may perform the prediction described above, under a premise that a current (a diagnosis outcome issuance time point, or a computation time point of a residual value indicated in a diagnosis outcome) residual value of the storage battery decreases linearly toward a predicted value of the residual value at predetermined future timing. Alternatively, the deposit management unit 14 may perform the prediction described above, under a premise that a current (a diagnosis outcome issuance time point, or a computation time point of a residual value indicated in a diagnosis outcome) residual value of the storage battery decreases toward a predicted value of the residual value at predetermined future timing according to a predetermined decrease function.

In this case, the deposit management unit 14 can decide to perform compensation in a case where a condition “the first difference is larger than a threshold value (accuracy is equal to or less than the criterion level)” is satisfied. Then, the deposit management unit 14 can determine payment of a larger compensation amount as a deviation between the first difference and the threshold value is larger.

Note that, the deposit management unit 14 may determine to perform compensation in a case where, in addition to the condition described above, another condition such as “predetermined usage condition is satisfied” is further satisfied. The usage condition defines that the electric equipment and the storage battery are used under such a condition that unexpected deterioration of the storage battery is not caused. A usage condition is, for example, that a travel distance of an electrically-powered vehicle (electric equipment) is equal to or less than a criterion value, that the number of times of charging the storage battery is equal to or less than a criterion value, or the like, but is not limited thereto.

Moreover, as a condition for receiving compensation, it may be determined that “a measured value of a residual value of an electric storage place at a compensation request” described above is measured by a predetermined measurement method. The predetermined measurement method may be, for example, computation based on a measured value of discharge current in a case of completely discharging from a fully charged state.

Moreover, as a condition for receiving compensation, it may be determined that “a user (buyer) who has purchased an electrically-powered vehicle regularly transmits, to the processing apparatus 10, post-purchase result information of a storage battery included in the purchased electrically-powered vehicle”. In this way, the processing apparatus 10 can acquire result information of the storage battery before and after purchase. Then, the processing apparatus 10 can determine, based on the information, whether to perform compensation, and a content of the compensation. For example, “a residual value of the storage battery at a time point of a compensation request” described above may be computed based on “post-purchase result information of the storage battery” transmitted to the processing apparatus 10 after purchase.

Payment of compensation money to the user (buyer) is achieved by any means. For example, the deposit management unit 14 may communicate with a server that manages predetermined electronic money, and pay compensation money in the predetermined electronic money. Alternatively, the deposit management unit 14 may pay compensation money by online transfer processing to a predetermined financial institution such as a bank or a post office.

### Refund Processing of a Deposit

The deposit management unit 14 refunds a deposit accepted from a diagnosis supplier, to the diagnosis supplier at predetermined timing. The deposit management unit 14 can execute at least one of refund examples indicated below.

### Orefund Example 1

In the example, a user who regularly transmits, to the processing apparatus 10, result information of electric equipment owned transmits, to the processing apparatus 10, an instruction to end the processing at any timing. The user performs the instruction, for example, at a time point of selling his/her electric equipment to another user. The user operates, for example, a user terminal 20, and accesses the processing apparatus 10 via an application or a web page involved in the processing apparatus 10. Then, the user performs the instruction via a UI screen on the application or the web page.

At a time point of accepting the instruction, the deposit management unit 14 refunds a deposit to some of the diagnosis suppliers. Specifically, the deposit management unit 14 refunds, to each diagnosis supplier, a deposit associated with a computation method other than a computation has been computed a diagnosis outcome issued to the user (a deposit deposited by a diagnosis supplier that has computed a residual value indicated in the diagnosis outcome).

There is a possibility that a deposit associated with a computation method that has computed a diagnosis outcome issued to the user is utilized in a subsequent compensation request. Thus, the deposit is not refunded to the diagnosis supplier at this time point.

### Refund Example 2

This example is a refund example of a deposit associated with a computation method that has computed a diagnosis outcome issued to a user.

The deposit management unit 14 refunds, to a diagnosis supplier at timing at which predetermined timing arrives, the deposit associated with the computation method that has computed the diagnosis outcome issued to the user. The predetermined timing is timing (end timing) at which compensation obligation to the user (buyer) ends.

The end timing may be, for example, timing at which a predetermined period has elapsed from a purchase time point of electric equipment. Alternatively, the end timing may be timing at which a predetermined period has elapsed from an issue date of a diagnosis outcome. Alternatively, the end timing may be timing at which a predetermined period has elapsed from a date of computing a residual value indicated in a diagnosis outcome. Alternatively, as illustrated in FIG. 9, in a case where a diagnosis outcome indicates a residual value at predetermined future timing, the end timing may be the predetermined future timing.

The deposit management unit 14 monitors arrival of the end timing as described above. Then, in response to arrival of the end timing, the deposit management unit 14 refunds, to the diagnosis supplier, the deposit associated with the computation method that has computed the diagnosis outcome issued to the user.

Refund of the deposit to the diagnosis supplier is achieved by any means. For example, the deposit management unit 14 may communicate with a server that manages predetermined electronic money, and refund the deposit in the predetermined electronic money. Alternatively, the deposit management unit 14 may communicate with a server of a predetermined credit card company, and refund the deposit. Alternatively, the deposit management unit 14 may refund the deposit by online transfer processing to a predetermined financial institution such as a bank or a post office.

Other components of the processing apparatus 10 according to the present example embodiment are similar to those according to the first to third example embodiments.

The processing apparatus 10 according to the present example embodiment achieves an advantage and an effect similar to those according to the first to third example embodiments. Moreover, the processing apparatus 10 can accept a deposit from a diagnosis supplier, and perform, by utilizing the deposit, compensation to the user (buyer) who has purchased electric equipment in buying and selling using a diagnosis outcome. As a consequence, it is expected that the diagnosis supplier strives to compute a residual value with higher accuracy in order to enhance a refund rate of the deposit. Moreover, the user (buyer) can confidently purchase the electric equipment.

### Fifth Example Embodiment

A processing apparatus 10 according to the present example embodiment includes a function of computing a reliability degree of each computation method. Then, the processing apparatus 10 can determine, based on the reliability degree, a fee to be paid to a diagnosis supplier for computation of a residual value. Moreover, the processing apparatus 10 can utilize the reliability degree in the processing described in the third example embodiment. Detailed description is given below.

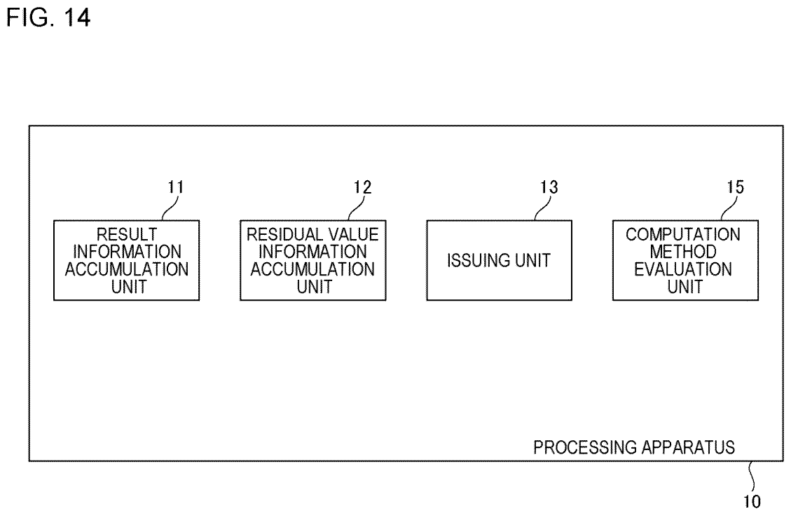

FIG. 14 illustrates one example of a functional block diagram of the processing apparatus 10 according to the present example embodiment. As illustrated in the figure, the processing apparatus 10 includes a result information accumulation unit 11, a residual value information accumulation unit 12, an issuing unit 13, and a computation method evaluation unit 15. Although not illustrated in the figure, the processing apparatus 10 may include a deposit management unit 14.

### Computation of a Reliability Degree of Each Computation Method

The computation method evaluation unit 15 computes a reliability degree of each of at least one computation method for computing a residual value of a storage battery. The computation method evaluation unit 15 can execute at least one of computation examples indicated below.

### Computation Example 1

It is assumed that residual value information computed by each computation method includes a current residual value, and a predicted value of a residual value at predetermined future timing.

The computation method evaluation unit 15 computes a reliability degree of each computation method, based on accuracy of a predicted value of a residual value at predetermined future timing indicated by residual value information computed in a past. Specifically, after “predetermined future timing indicated by residual value information computed in a past” arrives, the computation method evaluation unit 15 derives a difference between “a predicted value of a residual value at the predetermined future timing indicated by the residual value information computed in the past” and “a current residual value at that time”. Then, as the difference is smaller, the computation method evaluation unit 15 computes a higher reliability degree.

The “current residual value at that time” may be a current residual value at that time computed by each computation method, may be a statistical value (an average value, a median, a mode, and the like) of the current residual value at that time computed by a plurality of computation methods, or may be a value measured by a predetermined measurement method. The predetermined measurement method may be, for example, computation based on a measured value of discharge current in a case of completely discharging from a fully

### Computation Example 2

A diagnosis outcome issued by the issuing unit 13 is utilized in buying and selling of electric equipment including a storage battery. A utilization method is as described in the above example embodiment.

The computation method evaluation unit 15 computes, based on an outcome of the buying and selling, a reliability degree of a computation method that has computed a residual value indicated by a diagnosis outcome utilized in the buying and selling. Specifically, the computation method evaluation unit 15 computes a higher reliability degree in a case where buying and selling are accomplished. Then, in a case where buying and selling are not accomplished, a lower reliability degree is computed.

For example, the computation method evaluation unit 15 may compute a reliability degree of each computation method, based on the total number of times buying and selling have been accomplished. The computation method evaluation unit 15 computes a higher reliability degree as the total number of times buying and selling have been accomplished is larger.

Moreover, the computation method evaluation unit 15 may compute a reliability degree of each computation method, based on the total number of times buying and selling have been accomplished and the total number of times buying and selling have not been accomplished. The computation method evaluation unit 15 computes a higher reliability degree as the total number of times buying and selling have been accomplished is larger and probability that buying and selling are accomplished is larger. The probability that buying and selling are accomplished is computed by dividing the total number of times buying and selling have been accomplished, by the number of times of buying and selling (a sum of the total number of times buying and selling have been accomplished and the total number of times buying and selling have not been accomplished).

The computation method evaluation unit 15 computes a reliability degree of each computation method, based on at least one of a result of being specified in a past as a computation method of executing issue processing of a diagnosis outcome, and word-of-mouth information about the computation method.

The computation method evaluation unit 15 can compute a higher reliability degree as the number of times of being specified, in a past, as a computation method of executing of issue processing of a diagnosis outcome (the number of times of being specified in a past on such a UI screen as illustrated in FIG. 8) is larger.

Moreover, word-of-mouth information may indicate, for example, evaluation (example: 5-point evaluation) by a user. Then, the computation method evaluation unit 15 can compute a higher reliability degree as a statistical outcome (an average value, a median, a mode, and the like) of evaluation by a plurality of users is higher.

### Computation Example 4

A diagnosis outcome issued by the issuing unit 13 is utilized in buying and selling of electric equipment including a storage battery. Then, details of a diagnosis outcome are indicated on a web page introducing the electric equipment.

The computation method evaluation unit 15 can compute a reliability degree, based on at least one of the number of views of the web page, and the number of favorite registrations. Specifically, the computation method evaluation unit 15 can compute a higher reliability degree as the number of views is larger. Moreover, the computation method evaluation unit 15 can compute a higher reliability degree as the number of favorite registrations is larger.

### Computation Example 5

The computation method evaluation unit 15 can compute a reliability degree of each computation method, based on a result of performing compensation using a deposit described in the fourth example embodiment.

Specifically, the computation method evaluation unit 15 can compute a higher reliability degree as the number of times compensation using a deposit is performed is smaller. Moreover, the computation method evaluation unit 15 can compute a higher reliability degree as a sum of amounts of compensation using a deposit is lower.

### Computation Example 6

The computation method evaluation unit 15 can compute a reliability degree of each computation method, based on any plurality of the computation examples 1 to 5 described above. Specifically, the computation method evaluation unit 15 computes a reliability degree for each of a plurality of the computation examples, then integrates reliabilities of the computation, and computes a final reliability degree. A way of integration is not particularly limited, and can be exemplified by averaging, weighted averaging, adding up, multiplying, and the like, but is not limited thereto.

### Determination of a Fee to Be Paid to a Diagnosis Supplier for Computation of a Residual Value

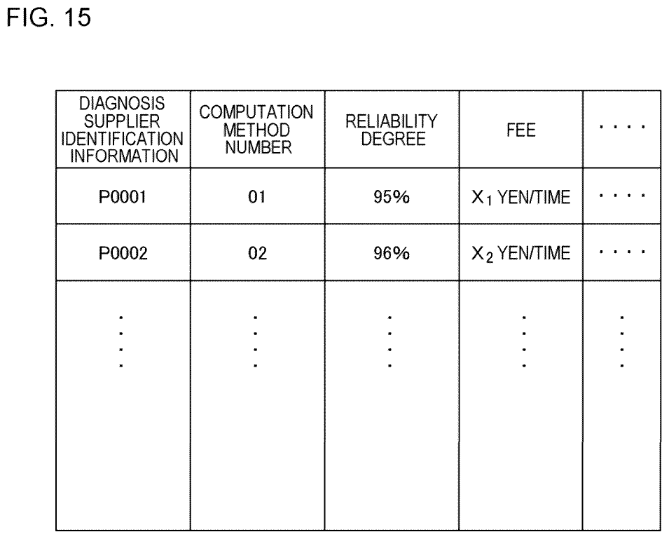

In the present example embodiment, for each time the residual value information accumulation unit 12 acquires residual value information and accumulates the residual value information in the residual value storage unit, a predetermined fee is paid to each diagnosis supplier that has computed the residual value information. The computation method evaluation unit 15 determines the fee, based on a reliability degree of each computation method that has been computed as described above. The computation method evaluation unit 15 determines a higher fee as the reliability degree is higher. FIG. 15 schematically illustrates one example of a content determined by the computation method evaluation unit 15.

### Another Utilization of a Reliability Degree

Moreover, as described in the third example embodiment, the issuing unit 13 can output characteristic information of each computation method to a user in association with a residual value computed by at least one computation method. After that, the issuing unit 13 accepts a user input specifying a residual value computed by at least one computation method, and executes issue processing of a diagnosis outcome indicating a residual value specified by the user input. Then, the “characteristic information of each computation method” can include a reliability degree of each computation method.

The issuing unit 13 can utilize a reliability degree computed by the computation method evaluation unit 15 as “characteristic information of each computation method”, and perform the processing described above.

Other components of the processing apparatus 10 according to the present example embodiment are similar to those according to the first to fourth example embodiments.

The processing apparatus 10 according to the present example embodiment achieves an advantage and an effect similar to those according to the first to fourth example embodiments. Moreover, the processing apparatus 10 can compute a reliability degree of each computation method, and determine, based on the reliability degree, a fee to be paid to a diagnosis supplier for computation of a residual value. Moreover, the processing apparatus 10 can present the reliability degree to a user. As a consequence, it is expected that a diagnosis supplier strives to further enhance a reliability degree.

### Modified Example

### Modified Example 1

The example embodiment has been described above on a premise that a residual value of a storage battery computed by a plurality of computation methods by a plurality of diagnosis suppliers is accumulated in a residual value storage unit, but a residual value of a storage battery computed by one computation method by one diagnosis supplier may be accumulated in a residual value storage unit.

### Modified Example 2

In the example embodiment described above, it is assumed that a residual value is computed repeatedly for one storage battery by each computation method, but a residual value may be computed only once for one storage battery by each computation method. For example, in a case where the processing apparatus 10 accepts an issue request for a diagnosis outcome from a user, the processing apparatus 10 may transmit result information accumulated so far in at least one server 30 (a server of a diagnosis supplier) in response to the issue request, and request computation of a residual value. Then, the processing apparatus 10 may present the user with the residual value computed in response to the request, and issue a diagnosis outcome indicating at least one specified from among the residual values.

The example embodiments of the present invention have been described above with reference to the drawings, but are exemplifications of the present invention, and various configurations other than those described above can be adopted. The components according to the example embodiments described above may be combined with each other, or some components may be replaced with other components. Moreover, various modifications may be made to the configuration according to the example embodiment described above without departing from the scope of the present embodiment. Moreover, the configurations and pieces of processing disclosed in each of the example embodiments and modified examples described above may be combined with each other.

Moreover, although a plurality of processes (pieces of processing) are described in order in a plurality of sequence diagrams used in the above description, an execution order of processes executed in each example embodiment is not limited to the described order. In each example embodiment, an order of illustrated processes can be changed to an extent that causes no problem in terms of content. Moreover, each of the example embodiments described above can be combined to an extent that content does not contradict.

Note that, in the present specification, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Some or all of the above-described example embodiments can also be described as, but are not limited to, the following supplementary notes.
1. A processing apparatus including:
   a result information accumulation unit that acquires result information relating to a utilization result of a storage battery, and accumulates the acquired result information in a result storage unit;
   a residual value information accumulation unit that acquires residual value information relating to a residual value of the storage battery computed based on the result information by at least one computation method, and accumulates the acquired residual value information in a residual value storage unit; and
   an issuing unit that executes issue processing of a diagnosis outcome indicating at least one specified residual value among the residual values computed by the at least one computation method.
2. The processing apparatus according to supplementary note 1, wherein
   the residual value information accumulation unit
      transmits the result information accumulated in the result storage unit to an external apparatus that computes the residual value information, based on the result information, and
      acquires the residual value information from the external apparatus.
3. The processing apparatus according to supplementary note 2, wherein
   the residual value information accumulation unit
      transmits the result information to a plurality of the external apparatuses, and acquires the residual value information from a plurality of the external apparatuses, and
   a plurality of the external apparatuses
      each compute the residual value information by the unique computation method.
4. The processing apparatus according to supplementary note 2 or 3, wherein
   the result information accumulation unit
      repeatedly acquires the result information of the storage battery, and accumulates the acquired result information in the result storage unit,
   the residual value information accumulation unit
      transmits the result information to a plurality of the external apparatuses at a frequency unique to each of the external apparatuses, and acquires the residual value information, and
   a plurality of the external apparatuses
      compute the residual value information at a frequency unique to each of the external apparatuses.
5. The processing apparatus according to any one of supplementary notes 1 to 4, wherein
   the residual value information includes a current residual value and a predicted value of a residual value at predetermined future timing.
6. The processing apparatus according to any one of supplementary notes 1 to 5, further including
   a deposit management unit that accepts a predetermined deposit in a case where the residual value information accumulation unit acquires the residual value information and accumulates the acquired residual value information in the residual value storage unit.
7. The processing apparatus according to supplementary note 6, wherein
   the issued diagnosis outcome is utilized in buying and selling of electric equipment including the storage battery, and
   the deposit management unit executes compensation processing using the deposit associated with the computation method that has computed the diagnosis outcome utilized in buying and selling of the electric equipment, in response to a compensation request from a buyer of the electric equipment.
8. The processing apparatus according to supplementary note 7, wherein
   the diagnosis outcome includes a predicted value of a residual value at predetermined future timing, and
   the deposit management unit determines whether to perform compensation and a content of the compensation, based on a residual value of the storage battery provided in the electric equipment at a time point of the compensation request and the predicted value.
9. The processing apparatus according to any one of supplementary notes 1 to 8, wherein
   the issuing unit
      outputs characteristic information of each of the computation methods to a user in association with the residual value computed by at least the one computation method, then accepts a user input specifying the residual value computed by at least the one computation method, and executes issue processing of a diagnosis outcome indicating the residual value specified by the user input.
10. The processing apparatus according to supplementary note 9, wherein
   the characteristic information indicates at least one of a number of times of computation of the residual value information performed so far in relation to the storage battery, a reliability degree, a result of being specified in a past as the computation method of executing issue processing of the diagnosis outcome, word-of-mouth information, and a result of predetermined processing utilizing the issued diagnosis outcome.
11. The processing apparatus according to any one of supplementary notes 1 to 10, further including
   a computation method evaluation unit that computes a reliability degree of each of at least the one computation method.
12. The processing apparatus according to supplementary note 11, wherein
   the residual value information includes a current residual value, and a predicted value of a residual value at predetermined future timing, and
   the computation method evaluation unit computes the reliability degree, based on a difference between a predicted value of a residual value at predetermined future timing indicated by the residual value information computed in a past, and a residual value at the predetermined timing.
13. The processing apparatus according to supplementary note 11 or 12, wherein
   the issued diagnosis outcome is utilized in buying and selling of electric equipment including the storage battery, and
   the computation method evaluation unit computes the reliability degree, based on an outcome of the buying and selling.
14. The processing apparatus according to any one of supplementary notes 11 to 13, wherein
   the computation method evaluation unit computes the reliability degree, based on at least one of a result of being specified in a past as the computation method of executing issue processing of the diagnosis outcome, and word-of-mouth information about the computation method.
15. The processing apparatus according to any one of supplementary notes 11 to 14, wherein
   the issued diagnosis outcome is utilized in buying and selling of electric equipment including the storage battery,
   details of the diagnosis outcome are indicated on a web page introducing the electric equipment, and
   the computation method evaluation unit computes the reliability degree, based on at least one of a number of views of the web page, and a number of favorite registrations.
16. The processing apparatus according to any one of supplementary notes 11 to 14, wherein
   the computation method evaluation unit determines, based on the reliability degree, a fee to be paid to each diagnosis supplier that has computed the residual value information for each time the residual value information accumulation unit acquires the residual value information and accumulates the acquired residual value information in the residual value storage unit.
17. A processing method including,
   by one or more computers:
      acquiring result information relating to a utilization result of a storage battery, and accumulating the acquired result information in a result storage unit;
      acquiring residual value information relating to a residual value of the storage battery computed based on the result information by at least one computation method, and accumulating the acquired residual value information in a residual value storage unit; and
      executing issue processing of a diagnosis outcome indicating at least one specified residual value among the residual values computed by the at least one computation method.
18. A medium recording a program causing a computer to function as:
   a result information accumulation unit that acquires result information relating to a utilization result of a storage battery, and accumulates the acquired result information in a result storage unit;
   a residual value information accumulation unit that acquires residual value information relating to a residual value of the storage battery computed based on the result information by at least one computation method, and accumulates the acquired residual value information in a residual value storage unit; and
   an issuing unit that executes issue processing of a diagnosis outcome indicating at least one specified residual value among the residual values computed by the at least one computation method.
19. A program causing a computer to function as:
   a result information accumulation unit that acquires result information relating to a utilization result of a storage battery, and accumulates the acquired result information in a result storage unit;
   a residual value information accumulation unit that acquires residual value information relating to a residual value of the storage battery computed based on the result information by at least one computation method, and accumulates the acquired residual value information in a residual value storage unit; and
   an issuing unit that executes issue processing of a diagnosis outcome indicating at least one specified residual value among the residual values computed by the at least one computation method.

### REFERENCE SIGNS LIST

10 Processing apparatus
11 Result information accumulation unit
12 Residual value information accumulation unit
13 Issuing unit
14 Deposit management unit
15 Computation method evaluation unit
20 User terminal
30 Server
40 User terminal
1A Processor
2A Memory
3A Input/output I/F
4A Peripheral circuit

What is claimed is:

1. A processing apparatus comprising:
at least one memory configured to store one or more instructions; and
at least one processor configured to execute the one or more instructions to:
acquire result information relating to a utilization result of a storage battery, and accumulate the acquired result information in a result storage device;
acquire residual value information relating to a residual value of the storage battery computed based on the result information by at least one computation method, and accumulate the acquired residual value information in a residual value storage device; and
execute issue processing of a diagnosis outcome indicating at least one specified residual value among the residual values computed by the at least one computation method.

2. The processing apparatus according to claim 1, wherein
the at least one processor is further configured to execute the one or more instructions to
transmit the result information accumulated in the result storage device to an external apparatus that computes the residual value information, based on the result information, and
acquire the residual value information from the external apparatus.

3. The processing apparatus according to claim 2, wherein
the at least one processor is further configured to execute the one or more instructions to
transmit the result information to a plurality of the external apparatuses, and acquire the residual value information from a plurality of the external apparatuses, and
a plurality of the external apparatuses
each compute the residual value information by the unique computation method.

4. The processing apparatus according to claim 2, wherein the at least one processor is further configured to execute the one or more instructions to
repeatedly acquire the result information of the storage battery, and accumulate the acquired result information in the result storage device,
transmit the result information to a plurality of the external apparatuses at a frequency unique to each of the external apparatuses, and
acquire the residual value information, and a plurality of the external apparatuses
compute the residual value information at a frequency unique to each of the external apparatuses.

5. The processing apparatus according to claim 1, wherein
the residual value information includes a current residual value and a predicted value of a residual value at predetermined future timing.

6. The processing apparatus according to claim 1, wherein the at least one processor is further configured to execute the one or more instructions to
accept predetermined deposit in a case where the at least one processor acquires the residual value information and accumulates the acquired residual value information in the residual value storage device.

7. The processing apparatus according to claim 6, wherein
the issued diagnosis outcome is utilized in buying and selling of electric equipment including the storage battery, and
the at least one processor is further configured to execute the one or more instructions to execute compensation processing using the deposit associated with the computation method that has computed the diagnosis outcome utilized in buying and selling of the electric equipment, in response to a compensation request from a buyer of the electric equipment.

8. The processing apparatus according to claim 7, wherein
the diagnosis outcome includes a predicted value of a residual value at predetermined future timing, and
the at least one processor is further configured to execute the one or more instructions to determine whether to perform compensation and a content of the compensation, based on a residual value of the storage battery provided in the electric equipment at a time point of the compensation request and the predicted value.

9. The processing apparatus according to claim 1, wherein
the at least one processor is further configured to execute the one or more instructions to
output characteristic information of each of the computation methods to a user in association with the residual value computed by at least the one computation method, then accept a user input specifying the residual value computed by at least the one computation method, and execute issue processing of a diagnosis outcome indicating the residual value specified by the user input.

10. The processing apparatus according to claim 9, wherein
the characteristic information indicates at least one of a number of times of computation of the residual value information performed so far in relation to the storage battery, a reliability degree, a result of being specified in a past as the computation method of executing issue processing of the diagnosis outcome, word-of-mouth information, and a result of predetermined processing utilizing the issued diagnosis outcome.

11. The processing apparatus according claim 1, wherein the at least one processor is further configured to execute the one or more instructions to
compute a reliability degree of each of at least the one computation method.

12. The processing apparatus according to claim 11, wherein
the residual value information includes a current residual value, and a predicted value of a residual value at predetermined future timing, and
at least one processor is further configured to execute the one or more instructions to compute the reliability degree, based on a difference between a predicted value of a residual value at predetermined future timing indicated by the residual value information computed in a past, and a residual value at the predetermined timing.

13. The processing apparatus according to claim 11, wherein
the issued diagnosis outcome is utilized in buying and selling of electric equipment including the storage battery, and
the at least one processor is further configured to execute the one or more instructions to compute the reliability degree, based on an outcome of the buying and selling.

14. The processing apparatus according to claim 11, wherein
the at least one processor is further configured to execute the one or more instructions to compute the reliability degree, based on at least one of a result of being specified in a past as the computation method of executing issue processing of the diagnosis outcome, and word-of-mouth information about the computation method.

15. The processing apparatus according to claim 11, wherein
the issued diagnosis outcome is utilized in buying and selling of electric equipment including the storage battery,
details of the diagnosis outcome are indicated on a web page introducing the electric equipment, and
the at least one processor is further configured to execute the one or more instructions to
compute the reliability degree, based on at least one of a number of views of the web page, and a number of favorite registrations.

16. The processing apparatus according to claim 11, wherein
the at least one processor is further configured to execute the one or more instructions to determine, based on the reliability degree, a fee to be paid to each diagnosis supplier that has computed the residual value information for each time the at least one processor acquires the residual value information and accumulates the acquired residual value information in the residual value storage device.

17. A processing method comprising,
by one or more computers:
acquiring result information relating to a utilization result of a storage battery, and accumulating the acquired result information in a result storage device;
acquiring residual value information relating to a residual value of the storage battery computed based on the result information by at least one computation method, and accumulating the acquired residual value information in a residual value storage unit; and
executing issue processing of a diagnosis outcome indicating at least one specified residual value among the residual values computed by the at least one computation method.

18. A non-transitory computer-readable medium recording a program causing a computer to:
acquire result information relating to a utilization result of a storage battery, and accumulate the acquired result information in a result storage device;
acquire residual value information relating to a residual value of the storage battery computed based on the result information by at least one computation method, and accumulate the acquired residual value information in a residual value storage device; and
execute issue processing of a diagnosis outcome indicating at least one specified residual value among the residual values computed by the at least one computation method.

19. The processing method according to claim 17, wherein
the one or more computers
transmit the result information accumulated in the result storage device to an external apparatus that computes the residual value information, based on the result information, and
acquire the residual value information from the external apparatus.

20. The non-transitory computer-readable medium according to claim 18, wherein
the program causing the computer to
transmit the result information accumulated in the result storage device to an external apparatus that computes the residual value information, based on the result information, and
acquire the residual value information from the external apparatus.
